(19) United States
(12) Patent Application Publication
(10) Pub. No.: US 2012/0203595 A1
(43) Pub. Date: Aug. 9, 2012

(54) Computer Readable Medium, File Server System, and Method for Market Segment Analysis, Selection, and Investment

(75) Inventor: Laura Patterson, Austin, TX (US)

(73) Assignee: VISIONEDGE MARKETING, Austin, TX (US)

(21) Appl. No.: 13/356,257

(22) Filed: Jan. 23, 2012

Related U.S. Application Data
(60) Provisional application No. 61/441,269, filed on Feb. 9, 2011.

(51) Int. Cl. G06Q 30/02

(52) U.S. Cl. 705/7.33

(57) ABSTRACT

In an embodiment, computer readable medium, file server system, and method include a marketing tool suite with a competitive advantage tool, a target tool, and an opportunity calculator tool. The marketing tool suites includes a plurality of instructions that, when executed by a processor, cause the processor to provide a graphical user interface including text, a plurality of user-selectable options, and text input fields to prompt a user through the plurality of marketing tools and receive user input based on a selected case to generate a marketing report.

### CROSS-REFERENCE TO RELATED APPLICATION(S)

This application is a non-provisional of and claims priority to U.S. Provisional Patent Application No. 61/441,269 filed on Feb. 9, 2011 and entitled “Marketing Tool Systems and Method,” which is incorporated herein by reference in its entirety.

### FIELD

The present disclosure is generally related to marketing systems, and more particularly to marketing tool systems and computer-aided methods.

### BACKGROUND

Conventionally, marketing segmentation and positioning are two of the most critical components associated with marketing strategy. Segmentation refers to a process of dividing a potential market made up of people or organizations into sub-sets with one or more characteristics that cause them to demand similar product and/or services based on qualities of those products such as price or function. A true market or customer segment is distinct from other segments (different segments have different needs), is homogeneous within the segment (exhibits common needs), responds similarly to a market stimulus, and can be reached by a market intervention. The term “segmentation” is sometimes used within the marketing industry to refer to instances when buyers and/or users with identical product and/or service needs are divided up into groups so they can be served or priced differently (e.g., a business customer as opposed to a residential customer). The people in a given segment are supposed to be similar in terms of criteria by which they are segmented and different from other segments in terms of these criteria.

While there may be theoretically ‘ideal’ market or customer segments, each organization engaged in a market will develop different ways of identifying market or customer segments, and will create its own product differentiation (positioning) strategies to exploit these segments. Positioning refers to a process of identifying a market niche for a brand, product or service utilizing traditional marketing placement strategies (i.e. price, promotion, distribution, packaging, and competition) and is defined as the way by which the marketers create an impression in the customer's mind with respect to a particular product, service, or brand. In particular, positioning refers to the aggregate perception the market has of a particular company, product or service in relation to their perceptions of the competitors in the same category. In some instances, positioning is facilitated by a graphical technique called perceptual mapping, various survey techniques, and statistical techniques, such as multi-dimensional scaling, factor analysis, conjoint analysis, and logit analysis.

The market or customer segmentation and corresponding product differentiation strategy can give an enterprise a temporary commercial advantage, if correctly applied. In other words, if the enterprise misunderstands its position in the marketplace or its market or customer segment, the enterprise may fail to realize a commercial advantage. Unfortunately, conventional marketing relies heavily on the experience and judgment of individual marketing professionals without direct insight into the analytical approaches of such professionals.

### BRIEF DESCRIPTION OF THE DRAWINGS

FIG. 1 is a block diagram of an embodiment of a system including a computing system for providing a marketing tool suite.

FIG. 2 is a diagram of a welcome screen of an embodiment of a user interface for accessing the marketing tool suite of FIG. 1.

FIG. 3 is a diagram of a marketing tool selection screen of an embodiment of a user interface for accessing the marketing tool suite of FIG. 1.

FIG. 4 is a diagram of a start screen of an embodiment of a user interface for configuring a marketing case using a competitive advantage tool of the marketing suite of FIG. 1.

FIG. 5 is a flow diagram of an embodiment of a method of configuring a competitive advantage tool of the marketing tool suite of FIG. 1 for a particular marketing case.

FIGS. 6-9 depict diagrams of embodiments of various screens of the user interface for entering and configuring competitive advantage information for the competitive advantage tool of the marketing tools suite of FIG. 1.

FIG. 10 is a diagram of a start screen of an embodiment of a user interface for configuring a target market case using a target tool of the marketing suite of FIG. 1.

FIG. 11 is a flow diagram of an embodiment of a method of configuring the target tool of the marketing tool suite of FIG. 1 for a particular target case,

FIGS. 12-15 depict diagrams of embodiments of various screens of the user interface for entering and configuring target information for the target tool of the marketing tools suite of FIG. 1.

FIG. 16 is a diagram of a start screen of an embodiment of a user interface for configuring an opportunity calculator case using an opportunity calculator tool of the marketing suite of FIG. 1.

FIG. 17 is a flow diagram of an embodiment of a method of configuring the opportunity calculator tool of the marketing tool suite of FIG. 1 for a particular opportunity calculator case.

FIGS. 18-20 depict diagrams of embodiments of various screens of the user interface for entering and configuring opportunity calculator information for the opportunity calculator tool of the marketing tools suite of FIG. 1.

In the following description, the use of the same reference numerals in different drawings indicates similar or identical items.

### DETAILED DESCRIPTION OF ILLUSTRATIVE EMBODIMENTS

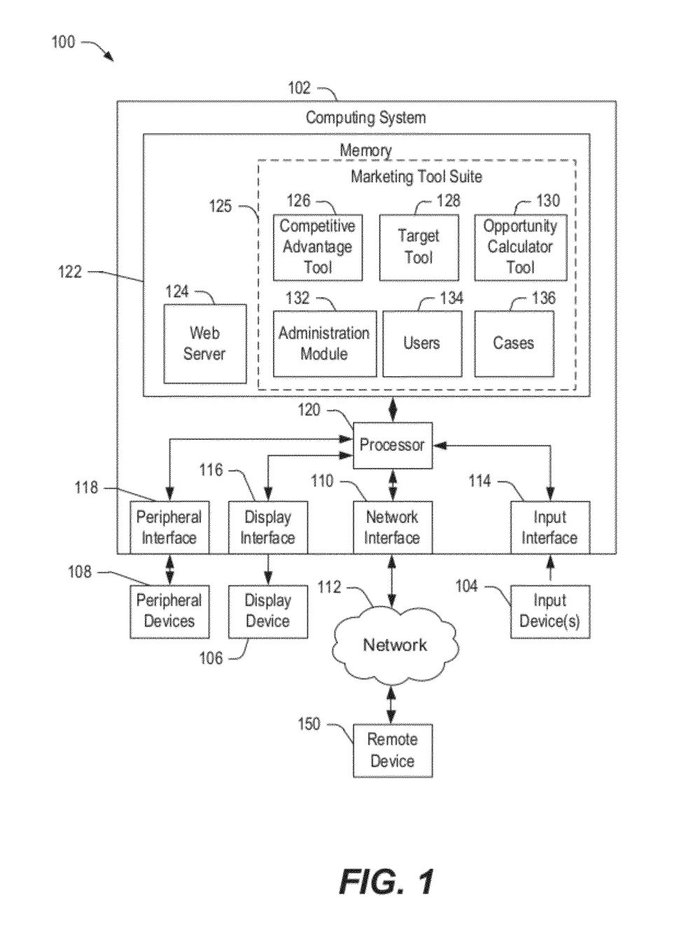

Embodiments of systems, methods and marketing tools are described below that prompt the user to enter a variety of input information and that provide the user with the means for viewing a potential market from numerous perspectives. Each tool prompts the user to enter data related to strategic questions. The tools operate on the user data to provide an analytical approach to positioning and segmentation. In some embodiments, the tools are provided as stand-alone applications that operate on a computing device, such as a personal computer, a hand-held computing device (such as a smart phone, a personal digital assistant (PDA), etc.), or other computing system. In other embodiments, the tools are provided as web-based user interfaces accessible from a server through execution of an Internet browser application. In either instance, a suite of marketing tools, such as competitive advantage tool, a target tool, and a market opportunity tool, assists users in reviewing and analyzing their market opportunities and marketing strategies to facilitate strategic marketing decision-making. An example of one possible embodiment of a server system for providing a suite of marketing tools is described below with respect to FIG. 1.

FIG. 1 is a block diagram of an embodiment of a system 100 including a computing system 102 for providing a marketing tool suite 125. Computing system 102 is connected to one or more input devices 104 for receiving user input, a display 106 (such as a liquid crystal display (LCD)) for providing visual information, and one or more peripheral devices 108 (such as a printer, a media player, and/or other types of devices). Further, computing system 102 is connected to a network 112, such as the Internet.

Computing system 102 includes a network interface 110 connected to network 112. Computing system 102 further includes an input interface 114 coupled to input device 104, a display interface 116 coupled to display 106, and a peripheral interface 118 coupled to one or more peripheral devices 108. Additionally, computing system 102 includes a processor 120 connected to input interface 114, network interface 110, display interface 116, and peripheral interface 118. Processor 120 is also connected to a memory 122. Memory 122 is a processor-readable (or computer-readable) medium that can store processor-readable instructions.

Memory 122 stores data and instructions, which are executable by processor 120 to provide access to the marketing tool suite 125 by one or more users via a corresponding one or more remote devices 150 through network 112. Memory 122 stores a web server application 124, which is executable by processor 120 to serve one or more web pages to remote devices through network 112. Further, memory 122 includes marketing tool suite 125, which includes a competitive advantage tool 126, a target tool 128, and an opportunity calculator tool 130. Marketing tool suite 125 also includes an administration module 132, users data 134, and cases data 136. As used herein, the term “case” refers to a database record that uniquely identifies a study for use with at least one component of the marketing tool suite 125 and associated with a business organization. Competitive advantage tool 126, target tool 128, opportunity calculator tool 130, and administration module 132 are independently accessible by users to input/edit data, create/edit cases, add/remove users, and produce and review marketing positioning, segmentation, and strategy reports.

Web server 124 provides a graphical user interface including data, input fields, and user-selectable options that are accessible by the user to selectively access the marketing tool suite 125. In particular, web server 124 hosts one or more applications/services and serves web pages associated with marketing tool suite 125. In particular, user interfaces provided by competitive advantage tool 126, target tool 128, and opportunity calculator tool 130 may be incorporated within web pages provided by web server 124 and the resulting Hyper-Text Markup Language (HTML) pages, Active Server Pages (ASP) documents, eXtensible Markup Language (XML) pages, etc. may be sent to remote device 150 through network 112 via network interface 110.

Competitive advantage tool 126, when executed by processor 120, provides a user interface to prompt the user through a process of identifying buying criteria against a particular set of buyers. Further, competitive advantage tool 126 prompts the user through a processor of evaluating competitors against the criteria and evaluating his/her own company against the criteria to determine potential opportunities and identify areas requiring improvement.

Target tool 128, when executed by processor 120, provides a user interface to prompt the user through a process of entering data to identify which markets, customers, or market/customer segments offer the potential for success against various market characteristics, including accessibility and opportunity. Further, target tool 128 provides outputs indicating target goals and projections for achieving the target outcomes.

Opportunity calculator tool 130, when executed by processor 120, provides a user interface to prompt the user through a process of entering data related to new and existing markets. Opportunity calculator 130 assists the user to understand the level of investment needed to pursue a selected market or customer segment, what market share will be needed to make the investment pay off, and the degree of confidence that the company can successfully penetrate the segment.

Administration module 132, when executed by processor 120, provides a user interface to prompt the user through a process of adding other authorized users. In some instances, such as where the marketing tool suite 125 is offered as a per-case or per-use software application through a network, administration module 132 may include billing/invoicing settings as well as security settings, case management settings, and the like. Further, administration module 132 may associate one or more users with a number of available cases of a particular type (e.g., competitive advantage cases associated with competitive advantage tool 126, target cases associated with target tool 128, and opportunity calculator cases associated with opportunity calculator tool 130). User data 134 stores data about authorized users as well as information relating to the various users' activities when such users login and use the system. Cases data 136 includes case information for cases created under each of the tools of the marketing tool suite 125

In a particular example, a user may access marketing tool suite 125 via web pages provided by web server 124 to remote device 150 through network 112 (for example in response to the user visiting a secure website and logging in). The user may then purchase one or more cases for use with a particular tool. In this instance, administration module 132 may associate the user's account with the one or more cases for the particular tool. In a particular example, for a fee, customers can purchase credits, as many credits as they desire, toward the use of the marketing tool suite 125. Each credit will allow the customer to create one case study and plot the results. In an example, each credit may be associated with a license (such as a user license or a site license), and multiple authorized users (customers) may be grouped under a single company or licenses so that more than one individual at a company may create cases and/or access existing cases.

In an example, web server 124 operates in conjunction with competitive advantage tool 126, target tool 128, and opportunity calculator tool 130 to capture user inputs, apply a number of analytical techniques, and produce an output to assist the user in market and customer segmentation and positioning. The user may interact with at least one of the competitive advantage tool 126, target tool 128, and opportunity calculator tool 130 to produce the selected type of marketing report.

In an example, administration module 132 can be configured to track usage for transaction-based billing of users (i.e., transaction-based credit card billing). In another example, administration module 132 can be configured to charge on a per-case basis. Depending on the implementation, different users may have difference billing settings. Computing system 102 is configurable to allow access by a large number of individuals, substantially concurrently.

While the above-discussion has largely focused on a network server implementation having a single computing system 102 implemented as a web server, it should be appreciated that the marketing tools suite 125 can be implemented on multiple servers, such as within a server farm, or on a single computing system 102 as shown. Further, in an alternative embodiment, the marketing tools suite 125 can be deployed onto a computer and run locally. In such an instance, the graphical user interface may still be rendered using an Internet browser application. Alternatively, the graphical user interface may be presented as a standalone application. Regardless of how the graphical user interface is rendered, the marketing tool suite 125 provides graphical user interfaces with user input options, user-selectable options, and text and graphic information. Examples of the graphical user interfaces are described below.

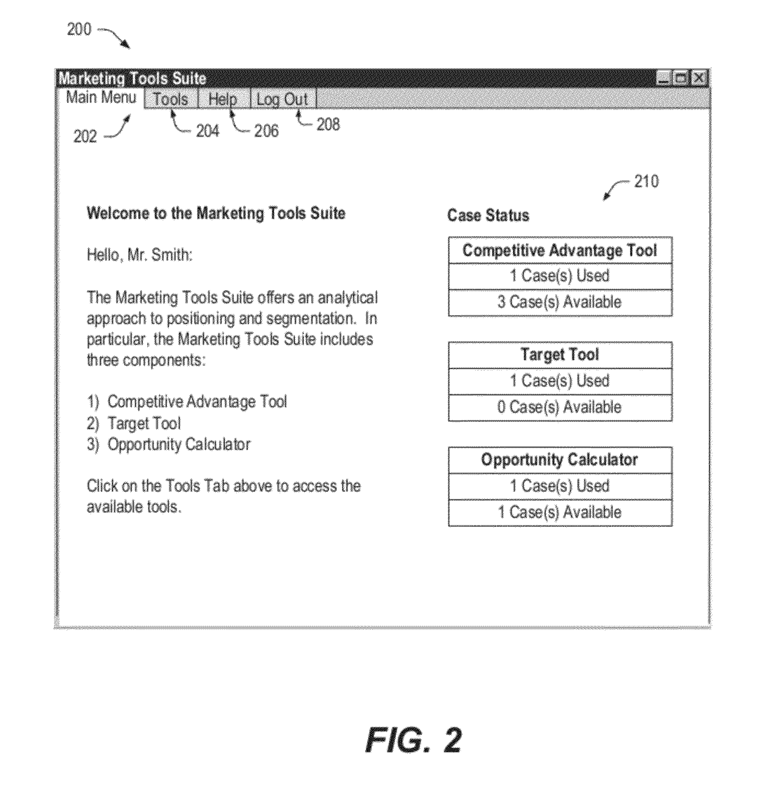

FIG. 2 is a diagram of a welcome screen of an embodiment of a user interface 200 for accessing the marketing tool suite 125 of FIG. 1. The welcome screen may be presented to the user after a successful login. In this instance, Mr. Smith has successfully logged in, and administration module 132 has accessed the user information in user data 134 to determine the user information associated with the login and to retrieve the case information for the user.

User interface 200 includes a first tab 202 labeled “Main Menu”, which displays the retrieved information including case status information 210. In this instance, the user has one used case and three available cases associated with competitive advantage tool 126, has one used case and no available cases associated with target tool 128, and has one used case and one available case associated with opportunity calculator tool 130. User interface 200 further includes a second tab 204 labeled “Tools”, which is accessible by the user to access the available tools within marketing tool suite 125. User interface 200 further includes a third tab 206 labeled “Help”, which is accessible by the user to access help information, and a fourth tab 208 labeled “Log Out”, which is accessible to log out of the system.

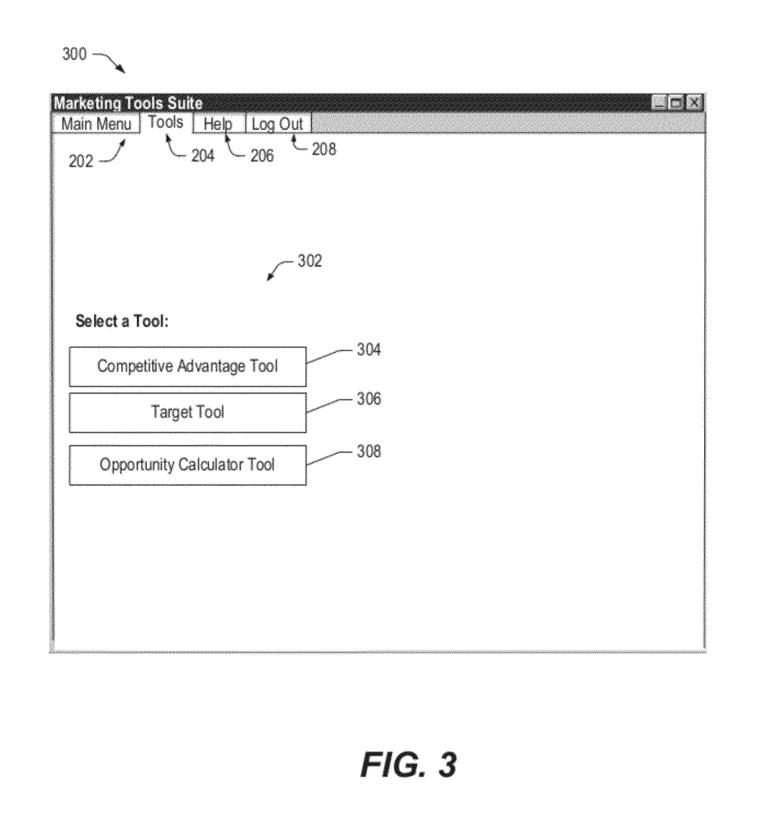

In an example, a user uses a stylus, a mouse, keys of a keyboard or keypad, or other means to select the second tab 204 labeled “Tools.” The tabs 202, 204, 206, and 208 may remain the same throughout the user interface. Selection of the second tab 204 causes the web server 124 to update the user interface with new information, such as that described below with respect to FIG. 3.

FIG. 3 is a diagram of a marketing tool selection screen of an embodiment of a user interface 300 for accessing the marketing tool suite 125 of FIG. 1. The marketing tool selection screen may be the first presented when the user selects the second tab 204 labeled “Tools.” User interface 300 includes a list of user-selectable options 302 including a first button 304 labeled “Competitive Advantage Tool”, a second button 306 labeled “Target Tool”, and a third button 308 labeled “Opportunity Calculator Tool.” Selection of any of the first, second, and third buttons triggers execution of the corresponding tool from the marketing tool suite 125.

### A. Competitive Advantage Tool

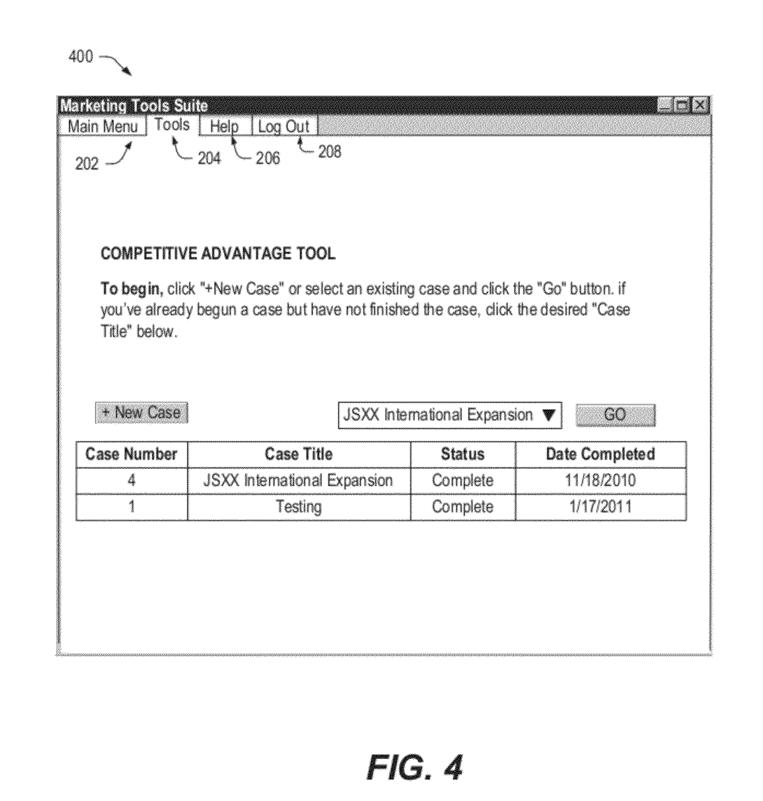

FIG. 4 is a diagram of a start screen 400 of an embodiment of a user interface for configuring a marketing case using a competitive advantage tool 128 of the marketing suite 125 of FIG. 1. Start screen 400 includes a brief explanation of how to begin. Further, start screen 400 includes a list of cases, which may be selected either via a pull down menu or by clicking on a title of the case in the list. Alternatively, the user may create a new case. If the user has no unused cases, selecting the “+New Case” button may direct the user to a payment screen to purchase a new case or may trigger a billing event (depending on the configuration of the user account). Within the list of cases, the status of the case and the completion date may be automatically created by the system or may be user configurable.

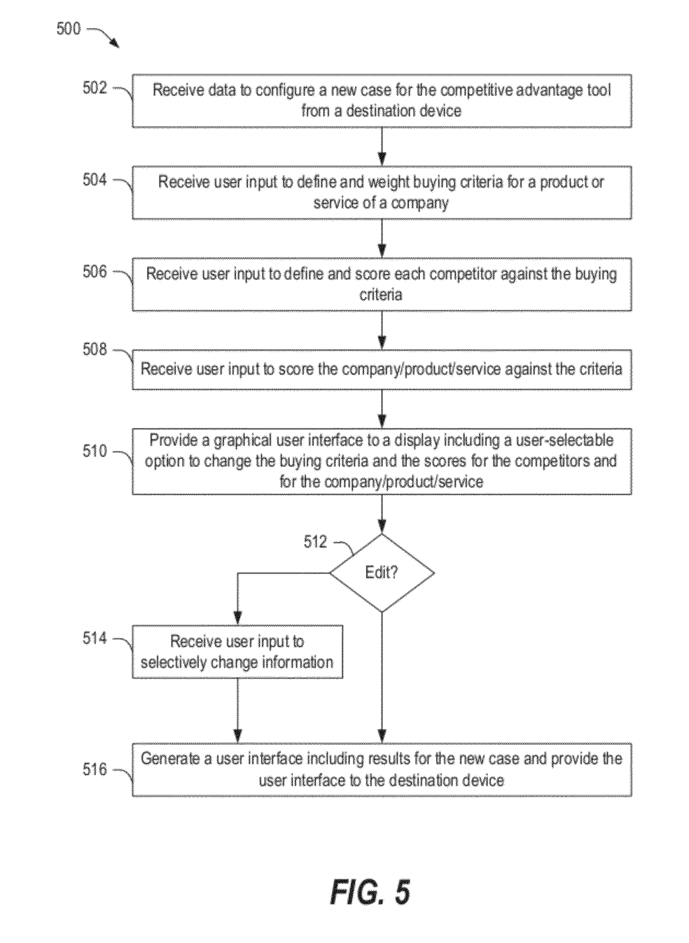

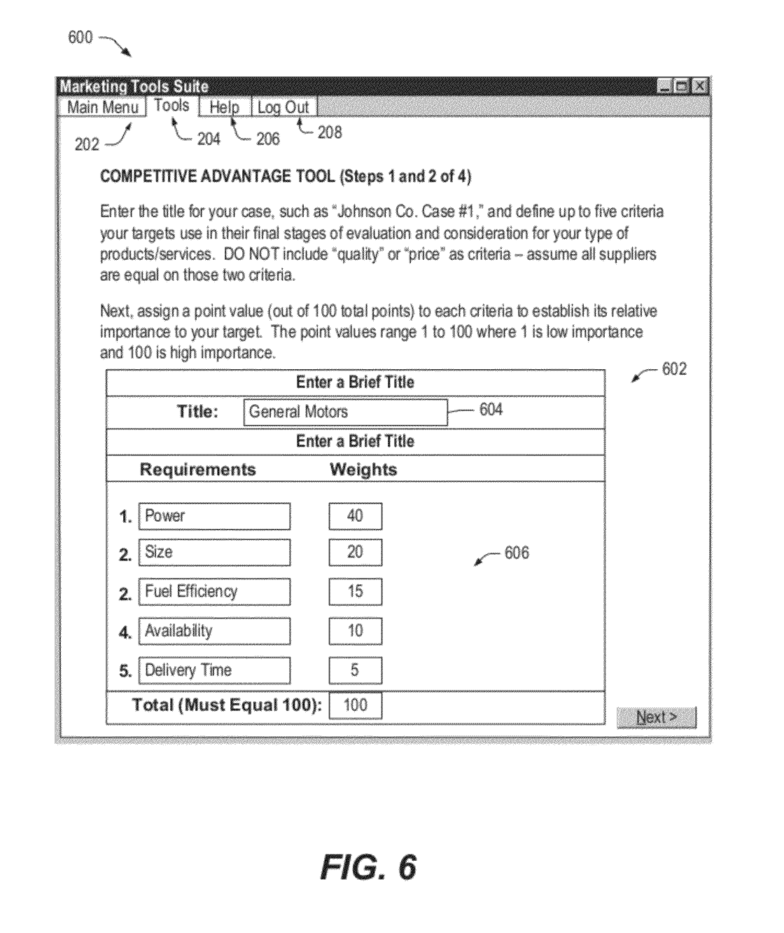

In general, once a case has been created, the user may interact with user-selectable options and text inputs as described below with respect to FIGS. 6-9) to configure the case information. An overview of the process from the perspective of computing system 102 is described below with respect to FIG. 5.

FIG. 5 is a flow diagram of an embodiment of a method 500 of configuring a competitive advantage tool of the marketing tool suite 125 of FIG. 1 for a particular marketing case. Web server application 124 is executed by processor 120 to provide a web interface to remote device 150 (or to display 106). The web interface includes an option for the user to log in. Upon togging in and selecting the first button 304 labeled “Competitive Advantage Tool” in FIG. 3 and upon selecting the “+New Case” button in FIG. 4, computing system 102 provides a user interface including user-selectable elements and user input fields for receiving user input to a destination device (such as remote device 150) or to display 106. Method 500 proceeds as if the user inputs are provided by a user via remote device 150; however, in an alternative example, the user inputs may be received from one or more input devices 104 and the user interfaces are display on display 106.

At 502, computing system 102 receives data to configure a new case for competitive advantage tool 126 from a destination device. Computing system 102 may provide a new user interface with different user-selectable options and inputs for receiving buying criteria information. Alternatively, the user interface may include multiple pages to receive the user inputs. Advancing to 504, computing system 102 receives user input to define and weight buying criteria for a product or service of a company. Moving to 506, computing system 102 receives user input to define and score each competitor against the buying criteria. Continuing to 508, computing system 102 receives user input to score the company/product/service against the buying criteria.

Proceeding to 510, computing system 102 provides a graphical user interface to the destination device including a user-selectable option to change the buying criteria and the scores for the competitors and for the company/product/service. Advancing to 512, if the user selects the user-selectable option to “edit” the data, the method 500 advances to 514 and computing system 102 receives user input to selectively change information previously provided by the user. Upon completion of 514 or if, at 512, the user elects not to edit the data, the method 500 continues to 516 and computing system 102 generates a user interface including results for the new case and provides the user interface to the destination device.

While the example depicted in FIG. 5 omits the transmissions of user interface data (e.g., new HTML pages, ASP pages, XML pages, etc.) from computing system 102 to remote device 150, it should be appreciated that such transmissions may occur between each “receive” step. In an alternative embodiment, the user interface may include multiple embedded pages for receiving the user input without back-and-forth communication with the web server application 124. In this alternative example, the user interface may submit the information only after the user presses a “submit” button or completes the last data entry page. Alternatively, at least a portion of the report may be generated using scripts embedded in the pages. Alternatively, some of the steps may be combined. For example, user input data in blocks 502 and 504 may be received in a single user interface, e.g., the user enters the data to configure the new case and the buying criteria within a single user interface, and then presses a “submit” or “next” button to provide the data to the computing system 102. An example of one possible sequence of user interfaces for receiving the data according to the method 500 is described below with respect to FIGS. 6-9.

FIGS. 6-9 depict diagrams of embodiments of various screens of the user interface for entering and configuring competitive advantage information for the competitive advantage tool of the marketing tools suite 125 of FIG. 1. FIG. 6 depicts an embodiment of a user interface 600 for receiving data to configure the new case and the buying criteria (blocks 502 and 504 in FIG. 5). User interface 600 includes a data entry area 602 including a text field 604 for receiving a title or name of the case and additional fields 606 for receiving buying criteria and associated weights, which aggregate to equal 100. Once the data entry is complete, the user can select the “Next” button to advance to a next stage for rating the competitors against the criteria.

In this instance, the weights are point values (out of 100 total points) assigned to each of the criteria to establish its relative importance. In this example, the point values range from 1 to 100 where 1 is of relatively low importance and 100 is of relatively high importance.

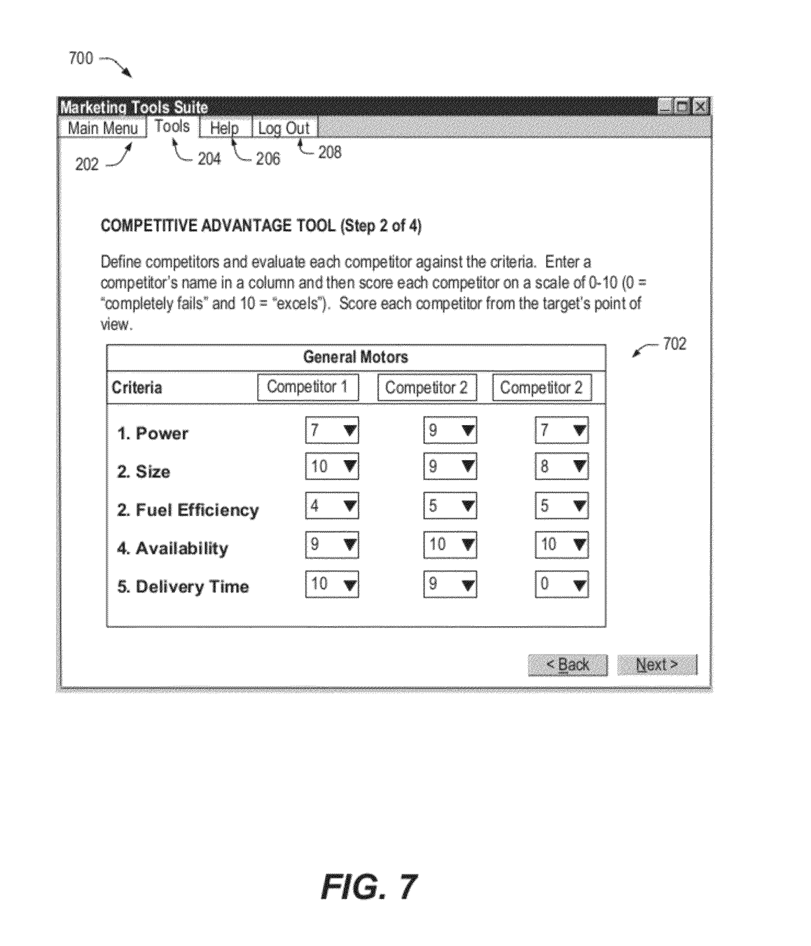

FIG. 7 is an embodiment of a user interface 700 for receiving data to configure competitors and to evaluate each competitor against the criteria (block 506 in FIG. 5). User interface includes a plurality of inputs and user-selectable elements (generally indicated at 702) for receiving user input. The user can interact with user interface to define competitors and evaluate each competitor against the criteria. Each competitor is scored on a scale from zero to ten (where zero represents “completely fails” and ten represents “excels”). In this instance, the user scores the competitor from the target's perspective. Once the data is entered, the user can either select the “Back” button to return to a previous user interface to edit the data or select the “Next” button to advance to the next screen.

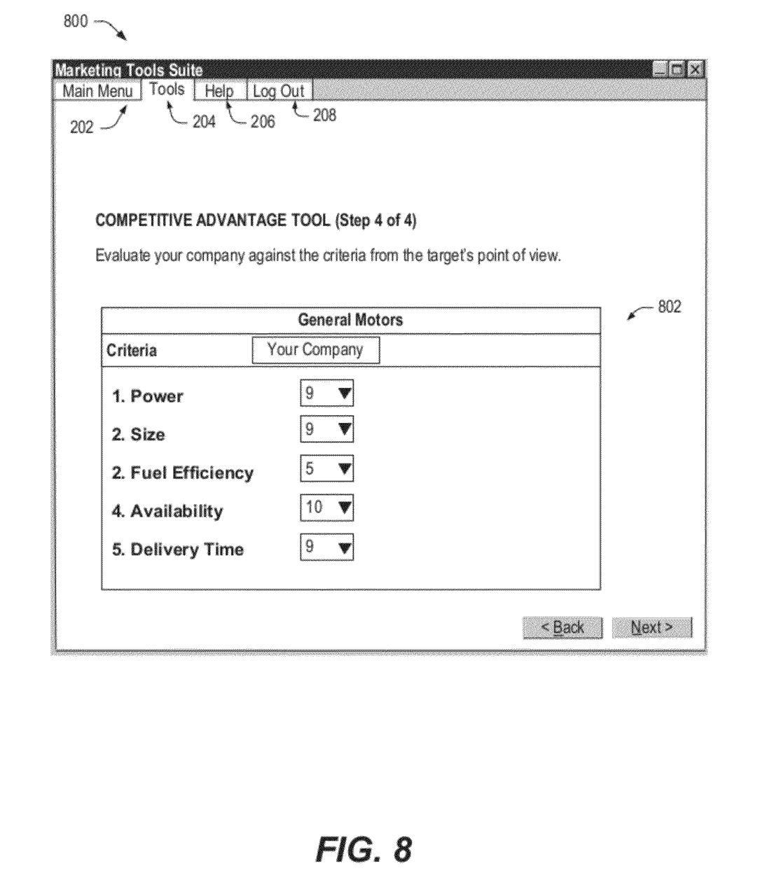

FIG. 8 is an embodiment of a user interface 800 for receiving data to evaluate the user's company against the criteria (block 508 in FIG. 5) from the target's perspective. As in the previous user interface 700, user interface 800 includes user-selectable (pull-down) menus (generally indicated at 802) for assigning a relative score for the user's company relative to the criteria. Once the data is entered, the user may either select the “Back” button to return to a previous user interface to edit the data or select the “Next” button to advance to the next screen.

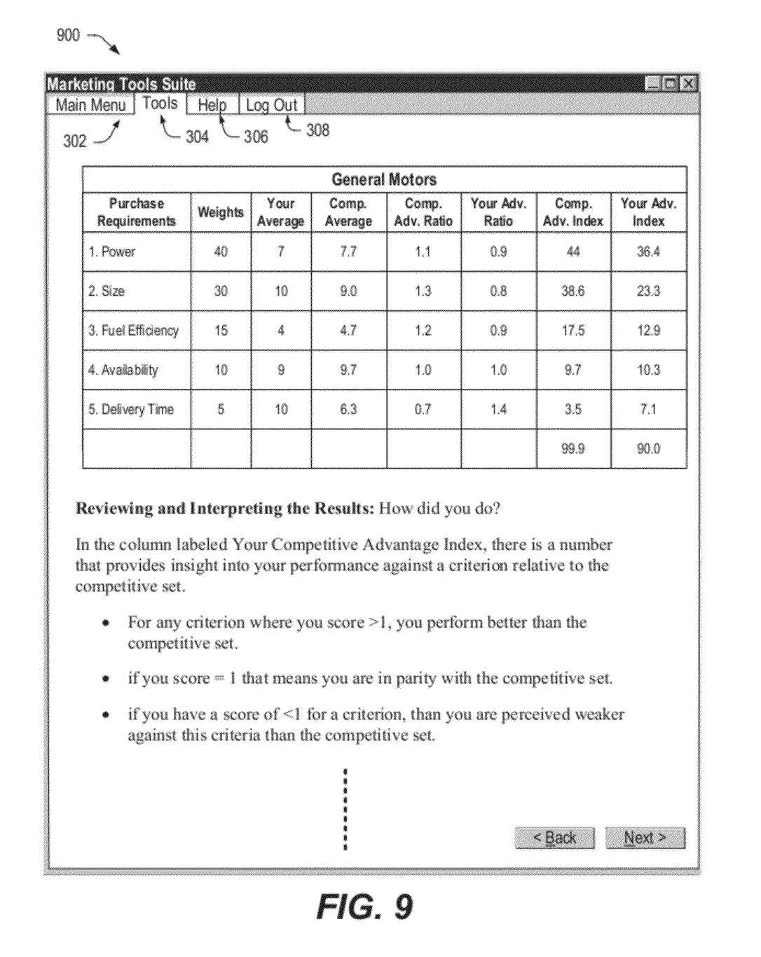

FIG. 9 is an embodiment of a user interface 900 for displaying the results from the data inputs of FIGS. 6-8. In one example, prior to displaying user interface 900, computing system 102 generates a user interface (not shown) that allows the user to review the data inputs and to go back to edit the data or proceed to user interface 900 if the data is correct.

User interface 900 displays the weights, the average of the user's company, the competitor's average, the competitor's average ratio, the user's company's average ratio, the competitor's advantage index, and the user's company's advantage index for each of the criteria. For any criteria where the user's company's advantage ratio is greater than one (1.0), the user's company performs better than the competition. If the user's company's advantage ratio is equal to one (1.0), the user's company is at parity with the competitors. If the user's company's advantage ratio is less than 1.0, the user's company is perceived to be weaker than the competitors for this criterion.

Other information may also be provided. For example, those attributes in which the company's advantage ratio is greater than one provide the best opportunity for a differential advantage. The goal would be to have a score that is greater than one for a criterion that is rated high in relative importance. Having a score greater than one on a relatively unimportant criterion suggests the competitors will be able to outpace and outmaneuver the company's efforts. A plan of improvement should be developed and deployed to address those criteria on which the score falls below one.

At the bottom of the Competitive Advantage Index column, there is a total. If the total number is greater than one hundred, the perception of the target for the user's company/product/service as a whole is better than that of the competitive set as a whole. An index equal to one hundred indicates that the user's company is at parity with the competitive set. An index of less than one hundred indicates that the user's company performs below the competitive set. Tracking this competitive advantage index provides the user with a meaningful metric that has implications for market share, brand equity, and for growing the lifetime value of the customers of the user's company. The user or his company can use this tool to monitor the score each quarter and assess whether the company is improving on the key attributes and to what extent.

The results may be graphically and numerically represented for clarity. The user may download the results, for example as a comma-delimited file readable in any spreadsheet program or database program. The advantage index immediately reveals how the company compares to the competitive set. The advantage ratio helps to assess the relative performance of the company for each criteria.

### B. Target Tool

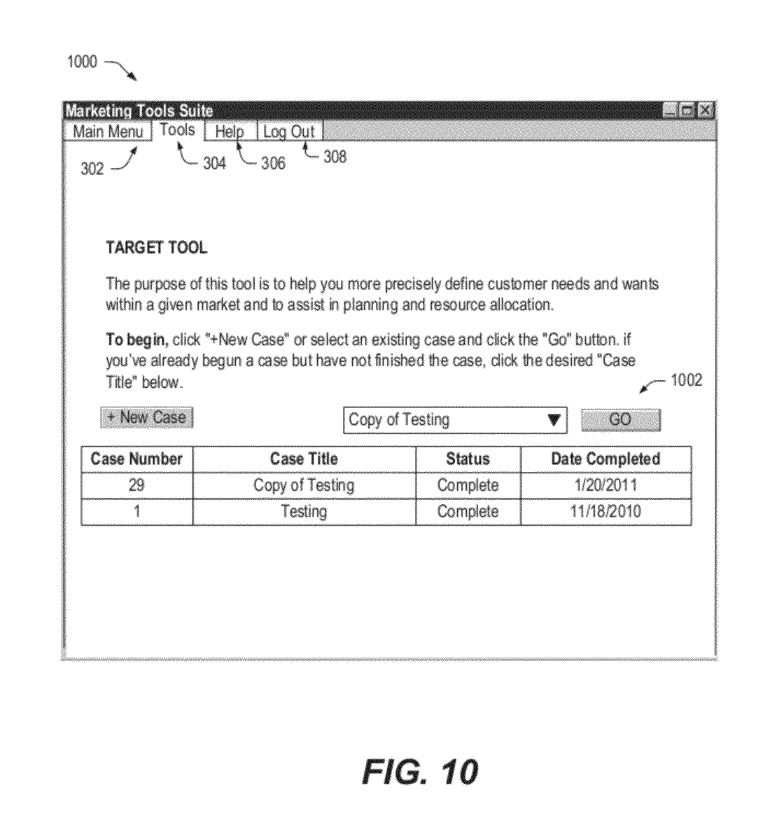

FIG. 10 is a diagram of a start screen 1000 of an embodiment of a user interface for configuring a target market case using a target tool of the marketing suite 125 of FIG. 1. A user accesses the start screen 1000 by selecting second button 306 labeled “Target Tool” within the user interface 300 of FIG. 3. Start screen 1000 includes a brief explanation of the purpose of the target tool 128 and an overview of how to begin. Further, start screen 1000 includes a list of cases, which may be selected either via a pull down menu or by clicking on a title of the case in the list. Alternatively, the user may create a new case. If the user has no unused cases, selecting the “+New Case” button may direct the user to a payment screen to purchase a new case or may trigger a billing event (depending on the configuration of the user account). Within the list of cases, the status of the case and the completion date may be automatically created by the system or may be user configurable.

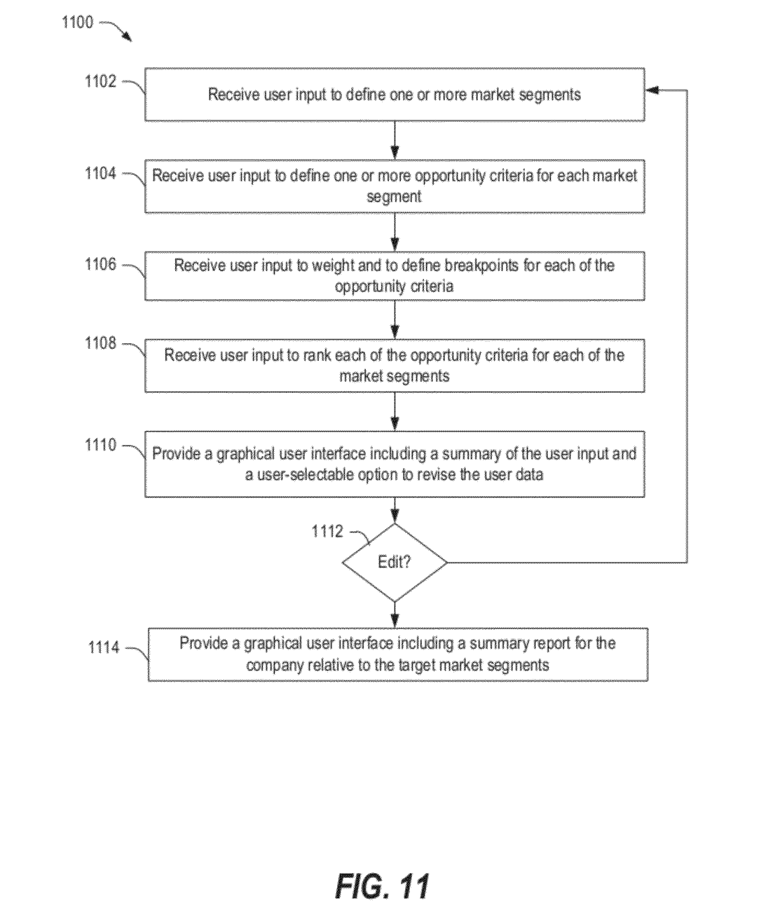

In general, once a case has been created, the user may interact with user-selectable options and text inputs (as described below with respect to FIGS. 11-15) to configure the case information. An overview of the process from the perspective of computing system 102 is described below with respect to FIG. 11.

FIG. 11 is a flow diagram of an embodiment of a method 1100 of configuring the target tool of the marketing tool suite 125 of FIG. 1 for a particular target case. Target tool 128 of marketing tool suite 125 assists the user to compare segments by evaluating them against the same criteria in two primary critical areas: the business opportunity each segment present the company and the degree of accessibility of the segment to the company. At 1102, computing system 102 receives a user input to define one or more market or customer segments. Advancing to 1104, computing system 102 receives user input to define one or more opportunity criteria for each market and customer segment. Continuing to 1106, computing system 102 receives user input to weight and to define breakpoints for each of the opportunity criteria. For example, to weight the criteria, one hundred points are allocated across the criteria, with more important criteria receiving a higher number. For each criterion, breakpoints are established to determine the degree at which the segment meets the criteria. For example, if revenue is a criterion for opportunity, the breakpoints might be rank 1 (lowest) is less than $500 million in annual revenue. Rank 2 (middle) is $501 million to $1 billion in annual revenue. Rank 3 (highest) has a revenue of over $1 billion.

Proceeding to 1108, computing system 102 receives user input to rank each of the opportunity criteria for each of the market and customer segments. In particular, for each segment, the user defines the ranking for each of the criterion and for each variable. To do this, the user may select from a drop down menu to select the correct ranking for that criterion. Moving to 1110, computing system 102 provides a graphical user interface including a summary of the user input and a user-selectable option to revise the user data. Continuing to 1112, if the user elects to edit the data, the method 1100 returns to 1102 (or to one of the other previous Hocks) to allow the user to edit the data. At 1112, if the user does not wish to edit the data, the method 1100 advances to 1114 and computing system 102 provides a graphical user interface including a summary report for the company relative to the target market and customer segments.

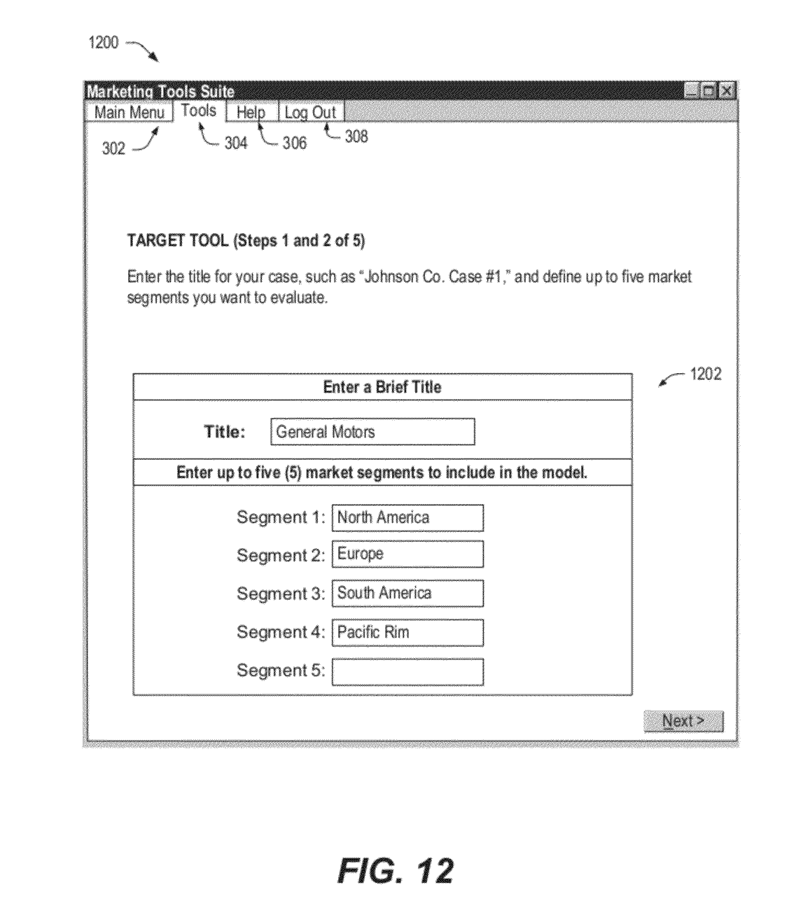

In a particular instance, computing system 102 maps the markets onto a grid to provide a quick and effective view of the relative merits of the segments. The results can be downloaded to a file if desired. Within the grid, the ranking for each criterion for each segment are used to plot the score onto the two axex: opportunity and accessibility. In one embodiment, the vertical axis plots the opportunity score and the horizontal axis plots the accessibility score. Examples of user interfaces to receive the user data described above in method 1100 are depicted below with respect to FIGS. 12-15.

FIGS. 12-15 depict diagrams of embodiments of various screens of the user interface for entering and configuring target information for the target tool of the marketing tools suite 125 of FIG. 1. FIG. 12 depicts an embodiment of a user interface 1200 for receiving data to configure the new case and the market and customer segment information (blocks 1102 and 1104 in FIG. 11). User interface 1200 includes a data entry area 1202 including a text field for receiving a title or name of the case and additional fields for receiving market and customer segment information. In this instance, the user has defined four geographical market segments: North America, Europe, South America, and Pacific Rim. It should be appreciated that segmentation may also be vertical, by industry, or horizontal by title, by usage frequency, or by demographic (such as revenue). Alternatively, segmentation can be by technology, such as a particular technology platform (e.g., SAP, ERM, etc). Other segments can also be used.

While FIG. 12 suggests only five segments may be entered, it should be appreciated that user interface 1200 is illustrative only. In other instances, any number of segments may be defined by the user. Once the data entry is complete, the user can select the “Next” button to advance to a next stage for configuring the opportunity criteria.

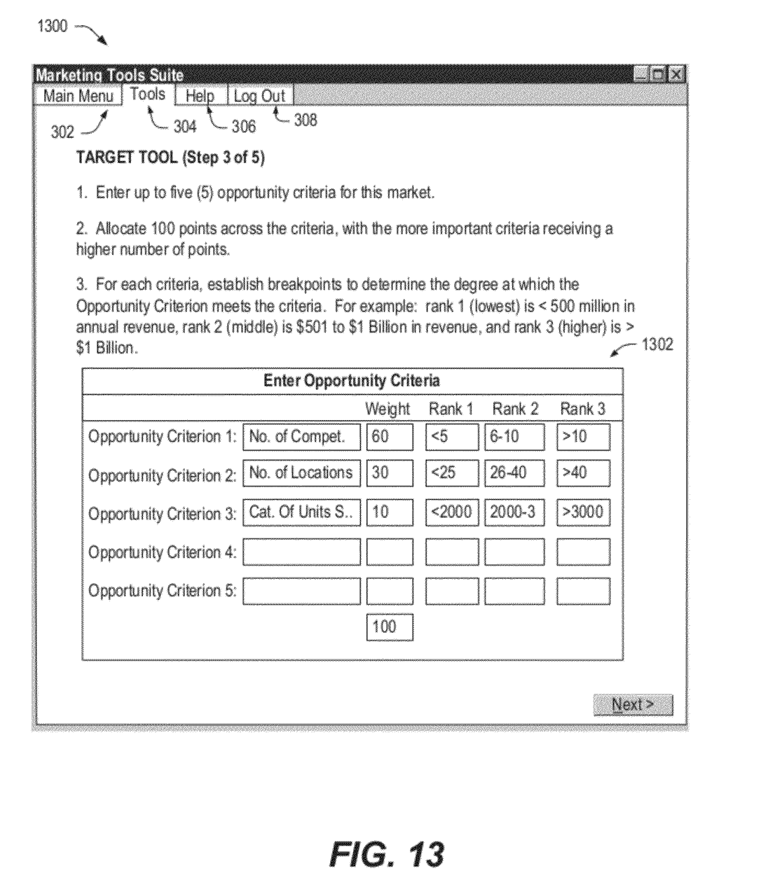

FIG. 13 is an embodiment of a user interface 1300 for receiving data to configure competitive opportunities and to rank and create breakpoints for each opportunity criteria (block 1106 in FIG. 11). User interface includes a plurality of inputs and user-selectable elements (generally indicated at 1302) for receiving user input. The user can interact with user interface to define opportunity criteria, weight the criteria, and rank them across the breakpoints.

In this instance, the user allocates one hundred points across the criteria with the more important criterion receiving more points. Breakpoints are established to determine the degree at which the opportunity criterion meets the specific breakpoint criteria. Once the data entry is complete, the user can select the “Next” button to advance to a next stage.

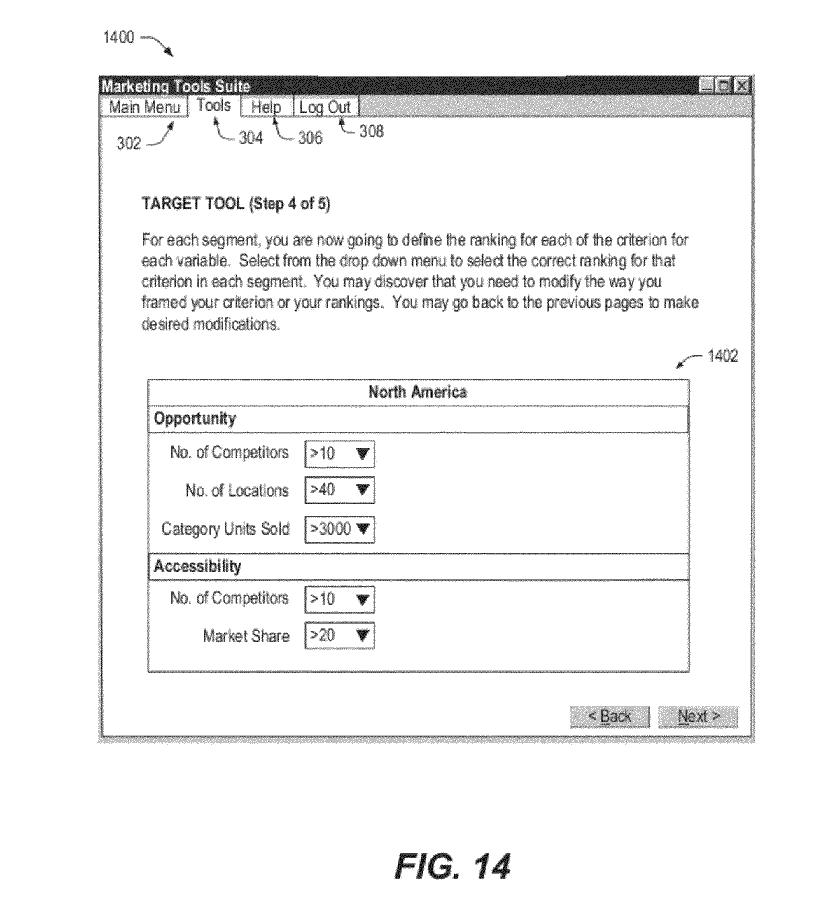

FIG. 14 is an embodiment of a user interface 1400 for receiving data to define a ranking for each criterion and for each variable (block 1108 in FIG. 11) from the target's perspective. As in the previous user interface 1300, user interface 1400 includes user-selectable (pull-down) menus (generally indicated at 1402) for assigning a market segment relative score for each criterion and for each variable. For example, within an Opportunity category, the user can select a range of a number of competitors, a range of the number of locations, and a range the categories of units sold. Within an accessibility category, again the user can select a range of the number of competitors, a range of the market share, etc. Once the data is entered, the user may either select the “Back” button to return to a previous user interface to edit the data or select the “Next” button to advance to the next screen.

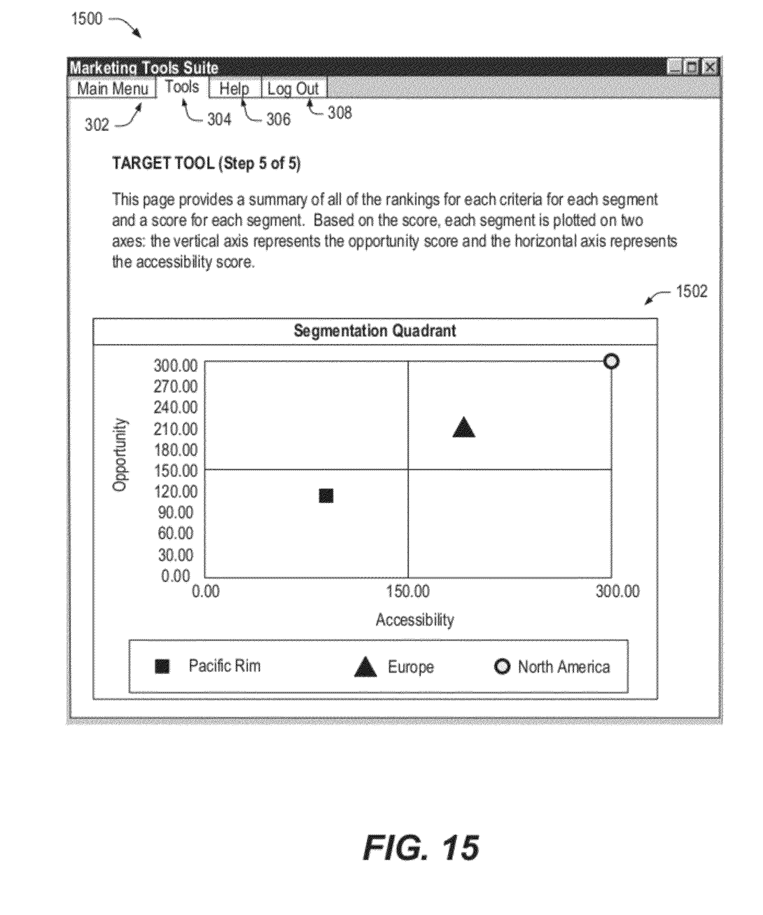

FIG. 15 is an embodiment of a user interface 1500 for displaying the results from the data inputs of FIGS. 12-14. In one example, prior to displaying user interface 1500, computing system 102 generates a user interface (not shown) that allows the user to review the data inputs and to go back to edit the data or proceed to user interface 1500 if the data is correct.

This same steps are completed by the user establishing the score for each segment for the accessibility category. Users identify and select the criteria and then establish the weighting and rankings for each category. Users evaluate each segment using the same 1-10 analysis. Identical to the opportunity category, each segment receives a score for each criterion and a total score for the accessibility. Upon completion of the process, each segment has both an accessibility and opportunity total score.

User interface 1500 includes a summary of all of the rankings for each criterion for each segment and a score for each segment. Based on the score, each segment can be plotted on two axes (vertical opportunity score and horizontal accessibility score). Other graphs may also be used. Further, the data may also be represented in tabular form, broken out by segment, opportunity, and accessibility for each criterion.

In the illustrated example, segments in the upper right hand quadrant are the segments that score high on both opportunity and accessibility. Segments in the upper left hand quadrant represent a good opportunity, but they are extremely difficult to access. Segments in the lower right hand quadrant have less opportunity, but have relatively easy access to this segment. Segments in the lower left hand quadrant represent neither good opportunities nor accessible segments.

### C. Opportunity Calculator Tool

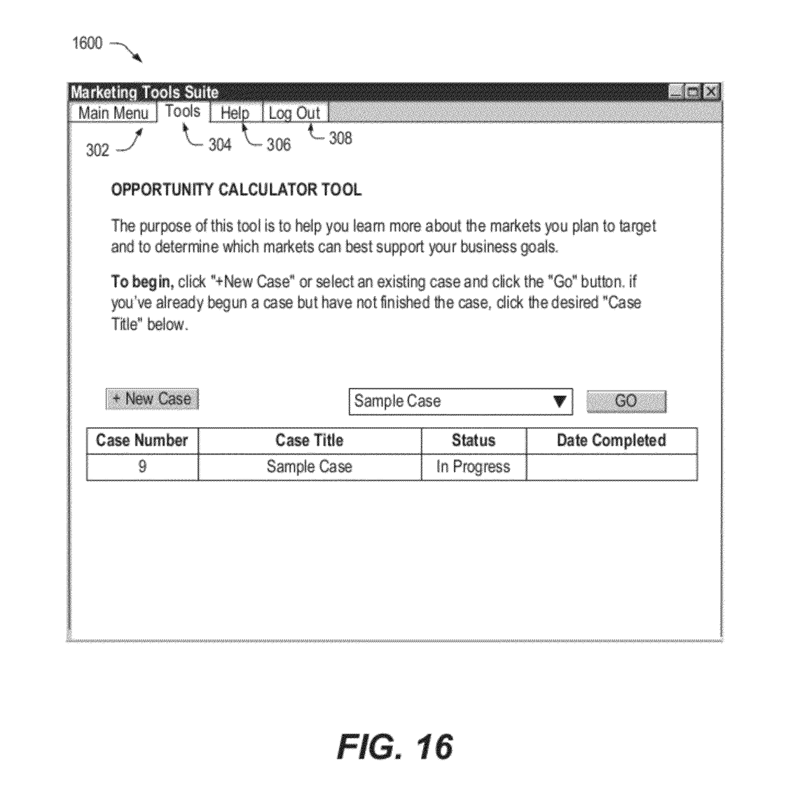

FIG. 16 is a diagram of a start screen 1600 of an embodiment of a user interface for configuring an opportunity calculator case using an opportunity calculator tool of the marketing suite 125 of FIG. 1. A user accesses the start screen 1600 by selecting third button 308 labeled “Opportunity Calculator Tool” within the user interface 300 of FIG. 3. Start screen 1600 includes a brief explanation of the purpose of the opportunity calculator tool 130 and an overview of how to begin. Further, start screen 1600 includes a list of cases, which may be selected either via a pull down menu or by clicking on a title of the case in the list. Alternatively, the user may create a new case. If the user has no unused cases, selecting the “+New Case” button may direct the user to a payment screen to purchase a new case or may trigger a billing event (depending on the configuration of the user account). Within the list of cases, the status of the case and the completion date may be automatically created by the system or may be user configurable.

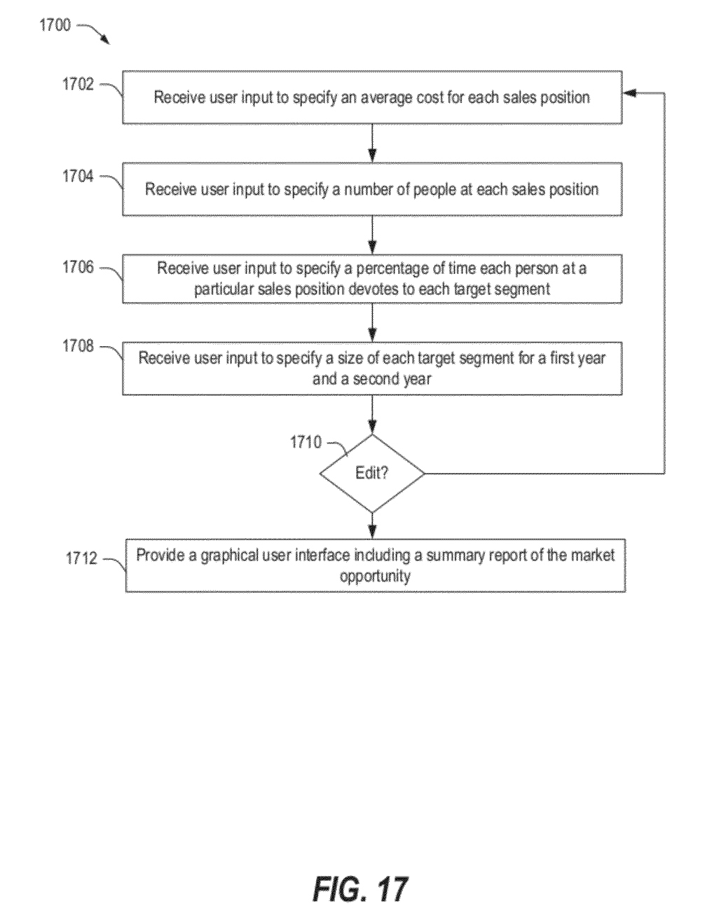

In general, once a case has been created, the user may interact with user-selectable options and text inputs (as described below with respect to FIGS. 17-20) to configure the case information. An overview of the process from the perspective of computing system 102 is described below with respect to FIG. 17.

FIG. 17 is a flow diagram of an embodiment of a method 1700 of configuring the opportunity calculator tool of the marketing tool suite 125 of FIG. 1 for a particular opportunity calculator case. At 1702, computing system 102 receives user input to specify an average cost for each sales position. Advancing to 1704, computing system 102 receives user input to specify a number of people at each sales position. Moving to 1706, computing system 102 receives user input to specify a percentage of time each person at a particular sales position devotes to each target segment. Continuing to 1708, computing system 102 receives user input to specify a size of each target segment for a first year and a second year. Proceeding to 1710, if the user wishes to edit the information, method 1700 returns 1702 (or to a different block) to allow the user to edit the information. Otherwise, at 1710, the method 1700 advances to 1712 and computing system 102 provides a graphical user interface including a summary report of the market opportunity.

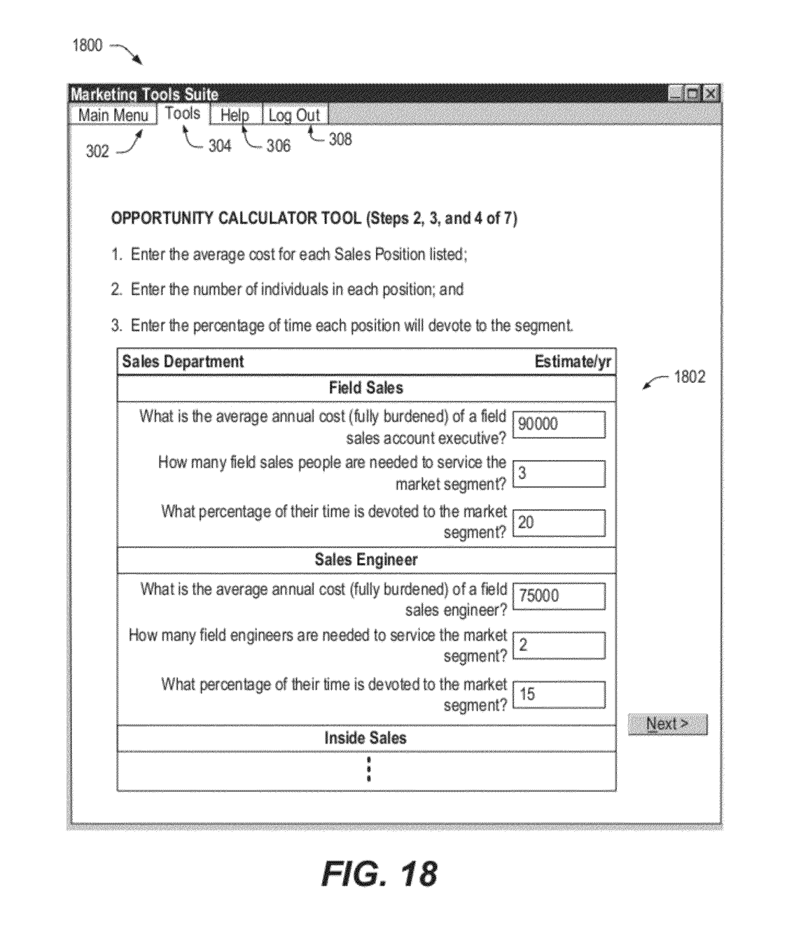

FIGS. 18-20 depict diagrams of embodiments of various screens of the user interface for entering and configuring opportunity calculator information for the opportunity calculator tool of the marketing tools suite 125 of FIG. 1. FIG. 18 depicts an embodiment of a user interface 1800 including user inputs 1802 for receiving data to enter the average cost of each sales position, the number of individuals in each sales position, and the percentage of time each position devotes to the segment (blocks 1702, 1704, and 1706 in FIG. 17). The sales positions can include field sales positions, sales engineer positions, inside sales positions, etc. Once the data entry is complete, the user can select the “Next” button to advance to a next stage for configuring the target segment size.

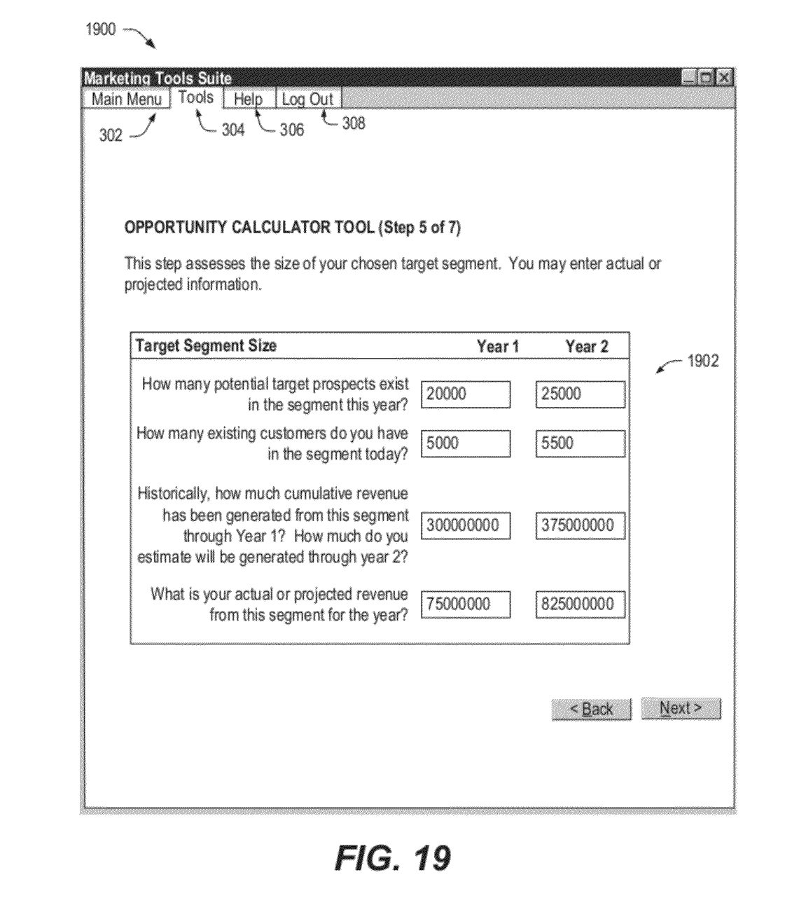

FIG. 19 is an embodiment of a user interface 1900 for receiving data to configure competitive opportunities and to rank and create breakpoints for each opportunity criteria (block 1708 in FIG. 17). User interface 1900 includes a plurality of inputs and user-selectable elements (generally indicated at 1902) for receiving user input. The user can interact with user interface to define the size of the chose target segments for a first year (Year 1) and a second year (Year 2).

In this instance, the size of the chosen target segment may be actual or projected information for either or both years. Actual information provides more accurate cost estimates.

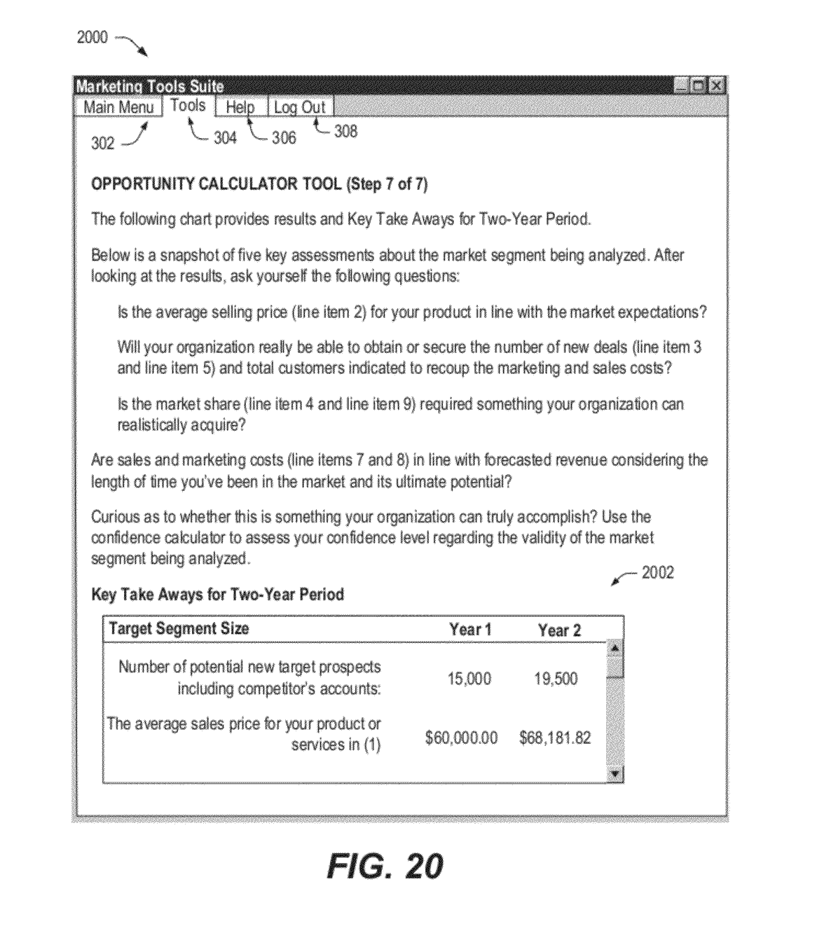

FIG. 20 is an embodiment of a user interface 2000 for displaying the results from the data inputs of FIGS. 18-19. In one example, prior to displaying user interface 2000, computing system 102 generates a user interface (not shown) that allows the user to review the data inputs and to go back to edit the data or proceed to user interface 2000 if the data is correct.

User interface 2000 displays the results 2002 and provides some text description lending insight into the results. In particular, user interface explains that the results 2002 provide a snapshot of the segments being analyzed. After looking at the results, the user should ask the following questions:
1) Is the average selling price (line item 2) for your product in line with the market expectations?
2) Will your organization really be able to obtain or secure the number of new deals (line item 3 and line item 5) and total customers indicated to recoup the marketing and sales costs?;
3) Is the market share (line item 4 and line item 9) required something your organization can realistically acquire?; and
4) Are sales and marketing costs (line items 7 and 8) in line with forecasted revenue considering the length of time you've been in the market and its ultimate potential?

Further, user interface 2000 can include a button or link to access a confidence calculator to determine a relative confidence level regarding the validity of the segment being analyzed.

In conjunction with the system, methods and interfaces described above with respect to FIGS. 1-20, a marketing tool suite receives user inputs relating to the user's company, competitor company's market and/or customer segments, buying criteria, and other information to provide multi-dimensional insights into the company's relative market performance. The system exposes opportunities for market gains as well as weaknesses, providing an analytical report for evaluating enterprise performance for any product, service or company.

Although the present invention has been described with reference to preferred embodiments, workers skilled in the art will recognize that changes may be made in form and detail without departing from the scope of the invention.

What is claimed is:

1. A computer readable medium comprising instructions that, when executed by a processor, cause the processor to:
generate a graphical user interface including text, a plurality of user-selectable options, and text input fields, the graphical user interface configured to prompt a user through a plurality of marketing tools including a competitive advantage tool, a target tool, and a market opportunity tool;
select one of the plurality of marketing tools;
receive user input based on the graphical user interface for a selected case in response to the selected one of the plurality of marketing tools; and
generate a marketing report for the selected one of the plurality of marketing tools and the selected case.

2. The computer readable medium of claim 1 further comprising instructions that, when executed by the processor, cause the processor to:
prompt the user to purchase a new case; and
receive user input based on the graphical user interface for the new case in response to the selected one of the plurality of marketing tools.

3. The computer readable medium of claim 1 further comprising instructions that, when executed by the processor, cause the processor to:
trigger a billing event to allow the user to create a new case; and
receive user input based on the graphical user interface for the new case in response to the selected one of the plurality of marketing tools.

4. The computer readable medium of claim 1, wherein when the one of the plurality of marketing tools is the competitive advantage tool, the instructions cause the processor to generate competitive advantage data by assessing a differential competitive advantage and potential pitfalls related to the selected case.

5. The computer readable medium of claim 1, wherein when the one of the plurality of marketing tools is the target tool, die instructions further cause the processor to generate target market data by establishing criteria for selecting a potential market related to the selected case.

6. The computer readable medium of claim 1, wherein when the one of the plurality of marketing tools is the market opportunity tool, the instructions further cause the processor to generate market opportunity data by assessing an opportunity related to the case and determine a likelihood of success corresponding to the opportunity.

7. The computer readable medium of claim 1, wherein the marketing report comprises an identified market area that requires improvements to meet a market potential.

8. The computer readable medium of claim 1, wherein the marketing report comprises a ranking of potential new market segments.

9. The computer readable medium of claim 1, wherein the marketing report comprises costs associated with accessing different market segments related to the case.

10. A file server system comprising:
a host processor;
a network interface coupled to the host processor and configured to communicate with a remote processor over a network;
a memory coupled to the host processor and adapted to store instructions that when executed by the remote processor, cause the remote processor to:
generate a graphical user interface including text, a plurality of user-selectable options, and text input fields, the graphical user interface configured to prompt a user through a prompt a user through a process of creating a case;
select one of a plurality of marketing tools including a competitive advantage tool, a target tool, and a market opportunity tool;
receive user input based on the graphical user interface for the case in response to the selected one of the plurality of marketing tools; and
generate a marketing report for at least one of the plurality of marketing tools and the case.

11. The file server system of claim 10, further comprising instructions that, when executed by the processor, cause the processor to:
prompt the user to purchase a new case; and
receive user input based on the graphical user interface for the new case in response to the selected one of the plurality of marketing tools.

12. The file server system of claim 10, further comprising instructions that, when executed by the processor, cause the processor to:
trigger a billing event to allow the user to create a new case; and
receive user input based on the graphical user interface for the new case in response to the selected one of the plurality of marketing tools.

13. The file server system of claim 10, wherein the competitive advantage tool generates competitive advantage data by assessing a company's competitive advantage and potential pitfalls related to the case.

14. The file server system of claim 10, wherein the opportunity calculator tool generates market opportunity data by assessing a likelihood of success of an opportunity related to the case.

15. The file server system of claim 10, wherein the target tool generates target market data by establishing criteria for selecting a potential market related to the case.

16. A method comprising:
generating a graphical user interface including text, a plurality of user-selectable options, and text input fields, the graphical user interface configured to prompt a user through a plurality of marketing tools including a competitive advantage tool, a target tool, and a market opportunity tool;
selecting one of the plurality of marketing tools;
receiving user input based on the graphical user interface for a selected case in response to the selected one of the plurality of marketing tools; and
generating a marketing report for the selected one of the plurality of marketing tools and the selected case.

17. The method of claim 16, further comprising:
purchasing a new case; and
receiving user input based on the graphical user interface for the new case in response to the selected one of the plurality of marketing tools.

18. The method of claim 16, further comprising:
triggering a billing event to create a new case; and
receiving user input based on the graphical user interface for the new case in response to the selected one of the plurality of marketing tools.

19. The method of claim 15, wherein generating the marketing report further comprises:
defining a buying criteria and scoring a user services and products against the buying criteria at the competitive advantage tool;
evaluating a plurality of market segments by assessing a business opportunity value and accessibility value for each of the plurality of segments; and
assessing a market opportunity level for each market segment, by assessing personal and resources necessary to access the market segment.

20. The method of claim 15, wherein generating the marketing report further comprises:
ranking a plurality of potential market segments based on available resources, market segment accessibility, and market opportunity.
